(19) United States
(12) Patent Application Publication
(10) Pub. No.: US 2026/0303128 A1
(43) Pub. Date: Oct. 1, 2026

(54) SYSTEM AND DESIGN METHOD OF A LOW BAND RADIO UNIT

(71) Applicant: JIO PLATFORMS LIMITED, Ahmedabad (IN)

(72) Inventors: Deepak GUPTA, Navi Mumbai (IN); Nekiram KHOSYA, Dombivali (IN); Renuka R, Dombivali (IN); Amrish BANSAL, Navi Mumbai (IN); Aayush BHATNAGAR, Navi Mumbai (IN); Pradeep Kumar BHATNAGAR, Navi Mumbai (IN)

(73) Assignee: JIO PLATFORMS LIMITED, Ahmedabad (IN)

(21) Appl. No.: 18/880,362

(22) PCT Filed: Apr. 12, 2024
(86) PCT No.: PCT/IN2024/050384

§ 371 Date: Dec. 31, 2024

(30) Foreign Application Priority Data
Apr. 29, 2023 (IN) 202321030830

(51) Int. Cl. H04B 1/00; H04W 76/10; H04W 88/08

(52) U.S. Cl. CPC H04B 1/0057; H04W 76/10; H04W 88/08

(57) ABSTRACT

The present disclosure provides a fifth generation (5G) new radio (NR) low band high power next generation Node B or a radio unit (100) operating in macro class. The radio unit (100) may include a fronthaul interface (102), an integrated baseband and transceiver board (IBTB) (104), a radio frequency front end board (RFEB) (106), and a duplexer filter and antenna interface unit (108).

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to a radio unit architecture. In particular, the present disclosure relates to a design of hardware architecture of fifth generation (5G) new radio (NR) low band radio unit for standalonemode.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Evolving communication outreach necessitates radio units capable of providing deep coverage in dense urban, medium urban, and rural morphologies. Further, the radio unit is required to provide deep indoor coverage as well. Increasing structural difficulty demands a more compact and a lightweight radiounit.

Furthermore, the presently available radio units face isolation issues, resulting in malfunctioning while operating in a low bandenvironment.

There is, therefore, a need in the art to provide an improved hardware architecture that can overcome the shortcomings of the existing prior arts.

### SUMMARY

In an exemplary embodiment, a radio unit (RU) is described. The RU comprises an integrated baseband and transceiver board (IBTB) configured to provide an interface for a plurality of radio frequency (RF) transceiver chains based on an integrated circuit. The IBTB comprises a lower layer physical (PHY) component in a network layer, an open radio access network (ORAN) compliant fronthaul on an optical interface. The RU comprises an antenna, a first blind mate, a second blind mate. The RU further comprises a radio frequency (RF) frond end (FE) board communicatively coupled to the IBTB. The RFEB comprises the transceiver chains and an observation chain. The RFEB is configured to interface the antenna and IBTB. The RU comprises a duplexer filter comprising at least one port for transmission chains, at least one port for receiver chains and at least one port for the antenna. The duplexer filter is configured to provide isolation between the transmitter chain, and the receiver chain and a steeper roll-off outside operatingband.

In some embodiments, the RFEB comprises a driver amplifier, a digital step attenuator, a power amplifier (PA), and a circulator.

In some embodiments, the IBTB further comprises a clock section including a system synchronizer and clock generator module. The system synchronizer and clock generator module are configured to provide precision time protocol (PTP) based clock synchronization on 10G optical interface.

In some embodiments, the duplexer filter is an integrated ×4 high power duplexer.

In some embodiments, the RFEB is configured to receive a plurality control signals from the IBTB along with a power supply through a connector.

In some embodiments, the RFEB is connected on the first blind mate with the IBTB and on the second blind mate with the duplexerfilter.

In some embodiments, the RU is configured to compensate system gain variation with respect to temperature in a downlink.

In some embodiments, the RU is configured to reduce a system noise figure with digital control.

In some embodiments, the IBTB further comprises a digital up converter (DUC), a digital down converter (DDC), a channel frequency response (CFR), a digital pre-distortion (DPD), a digital step attenuator, and a low noise amplifier (LNA).

In some embodiments, the RU further comprises a printed circuit board (PCB). The PCB comprises high direct current (DC) power system, plurality of high-speed interfaces running up to 10G, and a high-power RF system into a board including plurality of layers.

### Objects of the Present Disclosure

Some of the objects of the present disclosure, which at least one embodiment herein satisfies are as listed herein below.

An object of the present disclosure to provide a radio unit comprising lower layer physical (PHY) section with split 7.2X.

An object of the present disclosure is to provide a radio unit comprising open radio access network (ORAN) compliant Fronthaul on 10 gigabit (10G) optical interface.

An object of the present disclosure is to provide a radio unit comprising digital front end support using commercial grade field programmable gate array (FPGA)/application specific integrated circuit (ASIC) and multiple radio frequency (RF) transceiver chains.

An object of the present disclosure is to provide a radio unit with an increased isolation between transmitter and receiver chains and a steeper roll-off outside the operating band.

An object of the present invention is to provide a radio unit operable in low frequency bandrange.

An object of the present disclosure is to provide a radio unit comprising precision time protocol (PTP) based clock synchronization architecture.

An object of the present disclosure is to provide a radio unit comprising an integrated 4×4 high power duplexer to support frequency division duplex (FDD) system.

An object of the present disclosure is to provide a radio unit comprising blind mated and cable less design.

An object of the present disclosure is to provide a radio unit having a low weight and a compact form factor.

An object of the present disclosure is to provide a radio unit comprising an advanced printed circuit board (PCB) design to include high direct current (DC) power system, complex high-speed interfaces running up to 10G, and high-power RF system into a single eighteen or more layers board.

An object of the present disclosure is to provide a radio unit having a reduced noise figure and techniques to compensate system gain variations in downlink due to temperature.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary high-level architecture of a 4T4R fifth generation (5G) new radio (NR) low band radio unit (100), in accordance with some embodiments of the present disclosure.

FIG. 2 illustrates an exemplary high-level architecture of an Integrated Baseband and Transceiver Board (200) of the 4T4R 5G NR low band radio unit, in accordance with some embodiments of the present disclosure.

FIG. 3 illustrates an exemplary block diagram of a single chain of 4T4R RF front end board (300), in accordance with some embodiments of the present disclosure.

FIG. 4 illustrates an exemplary 4T4R 5G NR low band radio unit (400), in accordance with some embodiments of the present disclosure.

FIG. 5 illustrates an exemplary coupling representation of a user equipment with the radio unit, in accordance with some embodiments of the present disclosure.

FIG. 6 illustrates an exemplary computer system (500) in which or with which the 4T4R 5G NR low band radio unit may be implemented, in accordance with some embodiments of the present disclosure.

The foregoing shall be more apparent from the following more detailed description of the disclosure.

### LIST OF ELEMENTS

100 NR low band radio unit
102 fronthaul interface
104 IBTB
106 RFEB
108 antenna interface unit
110 connector
200 transceiver board
202 RFtransceiver
204 clock interface
206 front haul interface
208 interface
210 interface
212 interface
214 flash memory interface
216 radio frequency transceiver inter-faces
218 radio frequency transceiver inter-faces
220 interface
222 RGMII interface
224 interface
226 power supply interface
228 RF section controller
240W deliver
300 RFEB
302 pre-driver amplifier
304 pi-pads
306 driver
308 PAs
310 coupler
312 isolator
314 RF connector
316 DPD selector
400 NR low band radio unit
402 RET connector
404 pipe
412 power interface
414 n-type connectors
502 UE
504 wireless network
506 base station
600 exemplary computer system
610 external storage device
620 bus
630 main memory
640 read-only memory
650 mass storage
device 670 processor

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as setforth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment.

Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Certain terms and phrases have been used throughout the disclosure and will have the following meanings in the context of the ongoing disclosure.

The term “5G NR low band radio unit” may refer to a fifth-generation new radio low band radio unit operating in the 700-800 megahertz (MHZ) frequency range.

The term “4T4R” may refer to a 4×4 multi-input multi-output (MIMO) antenna, employing four antennas to establish up to four streams of data with a receiving device.

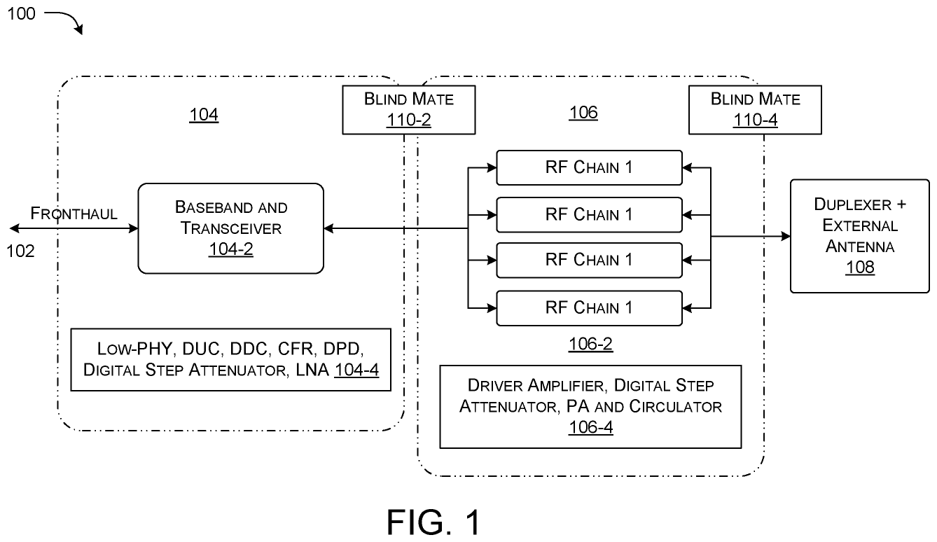

The various embodiments throughout the disclosure will be explained in more detail with reference to FIGS. 1-5.

FIG. 1 illustrates an exemplary high-level architecture of a 4T4R 5G NR low band radio unit (100), in accordance with some embodiments of the present disclosure.

Referring to FIG. 1, the radio unit (100) may include a fronthaul interface (102), an integrated baseband and transceiver board (IBTB) (104), a radio frequency front end board (RFEB) (106), and a duplexer filter and antenna interface unit (108). The radio unit (100) comprises a 5G NR low band high power NR node B operating in macro class. The macro class includes a power level of ≤47.8 dBm per antenna port and complements macro-level wide-area solutions for deep indoor coverage. Referring to FIG. 1, the radio unit (100) may be connected to a central unit (CU) and distributed unit (DU) on the fronthaul interface (102) using a 10G optical interface and may be open radio access network (ORAN) compliant. The DU handles radio resource control (RRC)/packet data convergence protocol (PDCP)/radio link control (RLC)/medium access control (MAC), and higher physical (PHY) layer functions.

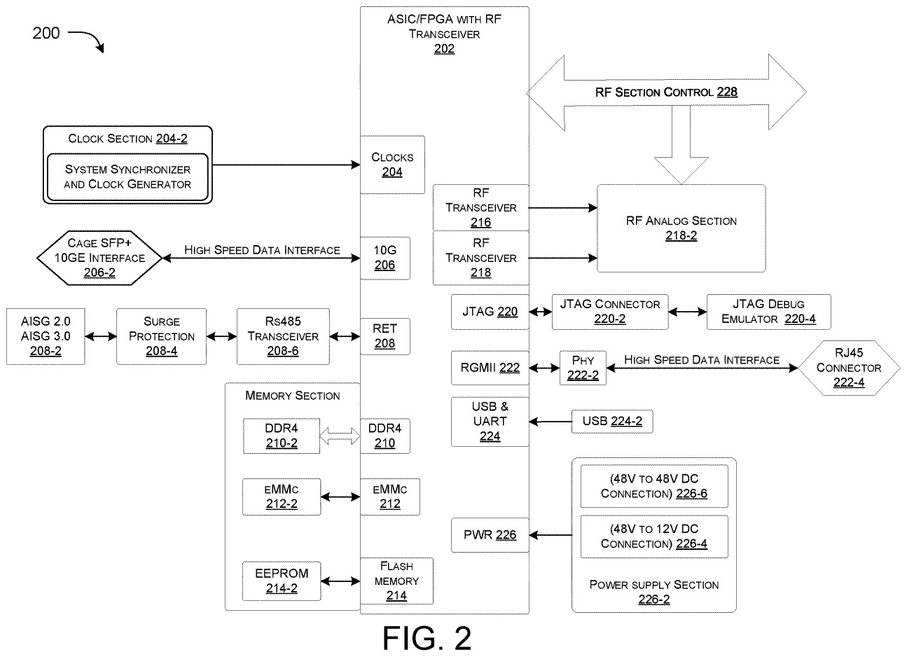

Referring to FIG. 1, the IBTB (104) includes baseband and transceiver (104-2) serving as an RF interface for the RFEB (106) and an application specific integrated circuit (ASIC)/field programmable gate array (FPGA) chipset handling the lower PHY layer functions comprising, without limitations, digital up converter (DUC), digital down converter (DDC), channel frequency response (CFR), digital pre-distortion (DPD), digital step attenuator, and low noise amplifier (LNA). It may be appreciated that the IBTB board architecture is explained in detail below with reference to FIG. 2.

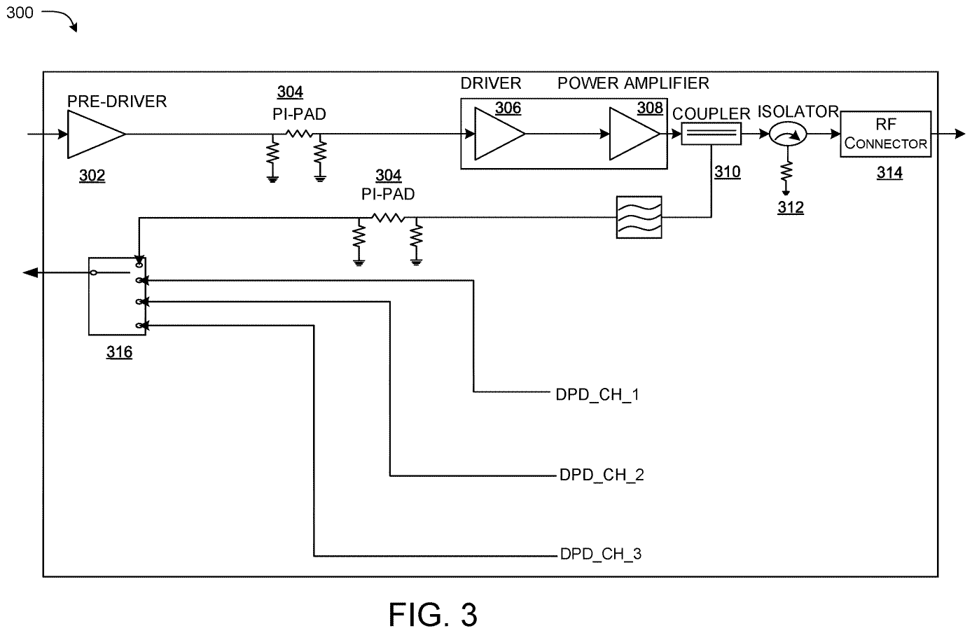

Referring to FIG. 1, the RFEB (106) receives control signals from the IBTB (104) along with a power supply through a connector (110-2). The connector (110-2) is a blind mate type of connector. The RFEB (106) consists of four transmit chains (106-2) for signal transmission and one observation chain (106-4) comprising driver amplifier, digital step attenuator, power amplifier (PA), and circulator. It may be appreciated that the RFEB (106) is explained in detail below with reference to FIG. 3.

Referring to FIG. 1, the RFEB (106) is connected to the duplexer filter and antenna interface unit or duplexer (108) through a connector (110-4). The RFEB (106) is blind mated with the duplexer (108). The duplexer filter consists of 4-ports for transmitter (Tx) chains, 4-ports for receiver (Rx) chains, and 4-ports for antenna for 4T4R or 4×4 MIMO configuration. The duplexer provides high isolation between Tx and Rx chains and steeper roll-off outside operating band. The steeper roll-off outside operating band provides attenuation of the signals rapidly outside the operating band. Due to the design, the duplexer provides passband response and thereby causing attenuation of signals outside the operating band. The duplexer may include, without limitations, a metallic cavity filter providing protection of Rx path from strong Tx signal of the same radio unit (100). The duplexer also provides protection from external out-of-band interferers and prevents mask violation at the Tx band. In some embodiments, the duplexer may be considered as a 3-port frequency division duplexer (FDD) device. The FDD acts as a filter enabling the radio unit (100) to achieve complete isolation between the transmitter and the receiver portions, which are on different boards, but working in the same time frame (simultaneous). This enables the radio unit (100) to operate in low band environment.

FIG. 2 illustrates an exemplary high-level architecture of an Integrated Baseband and Transceiver Board (200) of the 4T4R 5G NR low band radio unit, in accordance with some embodiments of the present disclosure.

The IBTB (200) includes ASIC/FPGA chip with RF transceiver (202). In FIG. 2, various interface circuitry are present in the IBTB (200), such as, a clock interface (204), a front haul interface (206), a remote electrical tilt (RET) interface (208), interface to peripheral memory circuits or memory section such as, without limitations, a Double Data Rate Fourth Generation Synchronous Dynamic Random-Access Memory (DDR4) interface (210), an embedded Multi Media Card (eMMC) interface (212), and a flash memory interface (214). The IBTB (200) further includes a power supply interface (226), a universal serial bus (USB)/universal asynchronous receiver transmitter (UART) interface (224), a reduced gigabit media-independent interface (RGMII) (222), a joint test action group (JTAG) interface (220), and radio frequency transceiver interfaces (216, 218). The clock interface (204) is connected to a clock section (204-2) including a system synchronizer and clock generator module, the front haul interface or 10G interface (206) is associated with Small Form-Factor Pluggable Plus (SFP+) cage connector (206-2), and the RET interface (208) is associated with antenna interface standards group (AISG 2.0/3.0) (208-2), surge protection (208-4), and RS-485 transceiver (208-6). Further, the memory interfaces including the DDR4 interface (210) is associated with DDR4 (210-2), the eMMC interface (212) is associated with the eMMC (212-2), and the flash memory interface (214) is associated with electrically erasable programmable read only memory (EEPROM) (214-2) in the memory section. The EEPROM (214-2) may include NAND/NOR type of flash memory section. The power interface (226) is connected to a power supply section (226-2) comprising 48V to 12V direct current (DC) convertor (226-4) and a 48V- to −48V direct current (DC) convertor (226-6). The USB/UART interface (224) is connected to a USB port (224-2), the RGMII interface (222) is connected to a RJ-45 connector (222-4) through a physical layer interface (222-2), the JTAG interface (220) is connected to a JTAG debug emulator (220-4) through a JTAG connector(220-2), and the RF transceiver interfaces (216, 218) interact with RF analog section(218-2) and are controlled by an RF section controller (228).

Referring to FIG. 2, an analog section of ASIC/FPGA (not shown) of IBTB (200) includes an interface to an analog to digital converter (ADC) (not shown) and a digital to analog converter (DAC) (not shown). The ADC and DAC interface from ASIC/FPGA analog section connect with four receive chains and four low power transmitter chains, which is further connected with a high-performance PA in the RFEB explained below with reference to FIG. 3. The ADC and DAC interface connected to the PA in RFEB delivers a desired output. The IBTB (200) further includes an observation chain which acts as DPD feedback path from PAs (308) of FIG. 3 in the RFEB (300) of FIG. 3 to ASIC/FPGA for linearization.

Referring to FIG. 2, the clock interface (204) includes precision time protocol (PTP) for synchronizing the entire radio unit (100) of FIG. 1. The complete system, i.e., the entire radio unit (100) of FIG. 1 is synchronized within the IBTB (200) through PTP on 10G fronthaul interface (206) while running PTP client to on board synchronization circuit, for example, the clock section (204-2). The clock section (204-2) includes clock generator circuit comprising ultra-low noise clock generation phased lock loops (PLLs), programmable oscillator, and a system synchronizer. In an embodiment, the IBTB (200) comprising FPGA/ASICs based RF transceivers (202), digital high-speed signals, switching power supplies, clock section (204-2), and radio frequency signal, is designed on eighteen or more layers printed circuit board (PCB). The PCB layer design includes techniques to routeRF signals and high speed 10GT/s to adjacent layers.

FIG. 3 illustrates an exemplary block diagram of a single chain of 4T4R RF front end board (300), in accordance with some embodiments of the present disclosure.

The RFEB (300) receives control signals from IBTB along with power supply through a connector (110-2) as shown in FIG. 1. The connector (110-2) is a blind mate type of connector. The RFEB (300) includes four transmit chains (106-2) for signal transmission and an observation chain (106-4). The observation chain (106-4) provides DPD feedback paths from PAs to ASIC transceiver for linearization. In FIG. 3, a single transmit chain including a pre-driver amplifier (302), pi-pads (304) for providing attenuation, a driver (306), a PA (308), a coupler (310), an isolator (312), an RF connector (314), and a DPD selector (316) are shown. The transmitter chain further includes a balance-unbalance (Balun) interface (not shown) for matching balanced load with unbalanced load. Each observation line carries the directional coupler (310), digital step attenuator (DSA), and matching network. A circulator and a 4×4 duplexer filter are used between each Rx chain, Tx chain, and antenna port to achieve isolation.

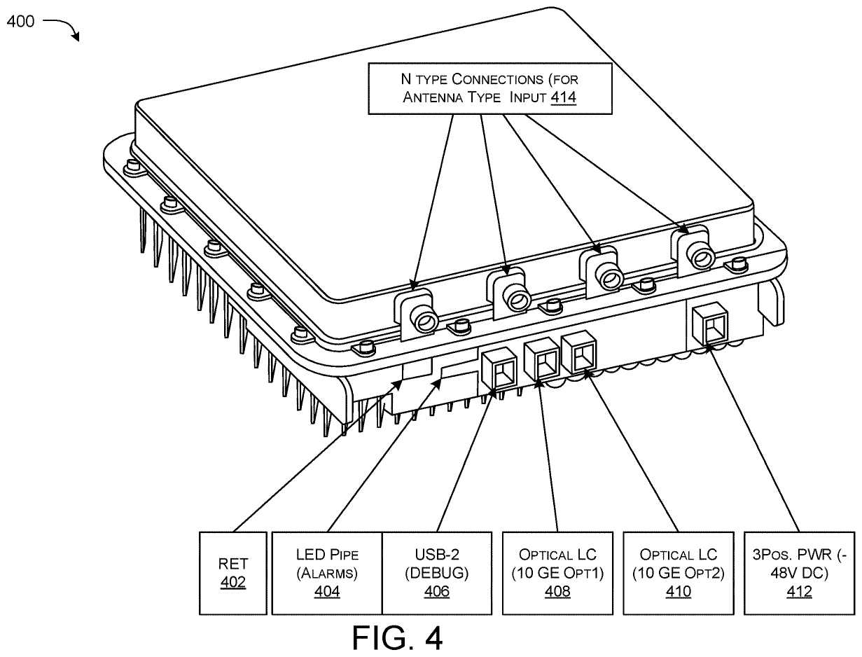

Referring to FIG. 3, the RFEB (300) may be developed on a multilayer substrate using embedded copper coin technology for high power laterally diffused metal oxide semiconductor (LDMOS) based PA (308) to deliver 240W output power efficiently. The RFEB (300) on one end blind mates (110-2) with the IBTB (104) of FIG. 1 and on another end blind mates (110-4) with the duplexer filter (108) of FIG. 1. The blind mating provides robust connection between IBTB (104) of FIG. 1 and RFEB (300), and avoids the complexity of cable routing, thereby eliminating/reducing RF signal oscillations. FIG. 4 illustrates an exemplary 4T4R 5G NR low band radio unit (400), in accordance with some embodiments of the present disclosure.

In FIG. 4, a hardware snapshot of the 4T4R 5G NR low band radio unit (400) is shown. The radio unit (400) includes an RET connector (402) which may be used as an antenna interface, a light emitting diode (LED) pipe (404) providing visual indication of one or more alarms, a USB-2 port (406) providing debugging connections, optical little connectors (LC) (408, 410) providing 10G front haul interfaces, and a power interface (412) for connecting to external power, for example, a 48V DC supply. The radio unit (400) further includes a plurality of N-type connectors (414) for receiving antenna type inputs. The 5G NR low band radio unit (400) also includes gain control unit that is configured to control a system gain. Due to variations in temperature, some components may experience variations in their operating range leading to change in variation in system gain. The gain control unit increases the system gain when the system gain decreases beyond a first threshold due to temperature, and decreases the system gain when the system gain increases a second threshold due to temperature. In some examples, an automatic gain control (AGC) may be used. In some examples, feedback-based gain control may be used as the gain control unit. Other examples not described here are contemplated herein. A person of ordinary skill in the art will appreciate that these are mere examples, and in no way, limit the scope of the present disclosure.

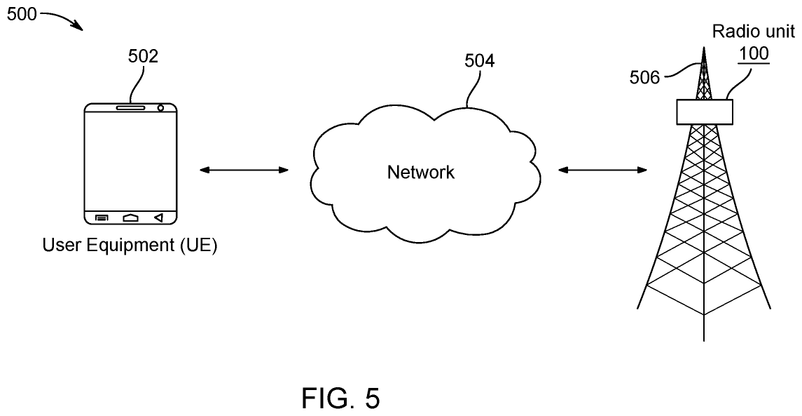

FIG. 5 illustrates an exemplary coupling representation of a user equipment (UE) with the MRU. As illustrated, the UE (502) may be communicatively coupled to the radio unit (100) associated with base station (506). The coupling can be through a wireless network 504. In an exemplary embodiment, the communication network (504) may include, by way of example but not limitation, at least a portion of one or more networks having one or more nodes that transmit, receive, forward, generate, buffer, store, route, switch, process, or a combination thereof, etc., one or more messages, packets, signals, waves, voltage or current levels, some combination thereof, or so forth. The UE (502) can be any handheld device, mobile device, palmtop, laptop, smart phone, pager and the like. As a result of the coupling, the UE (502) may be configured to receive a connection request from the radio unit (100), send an acknowledgment of connection request to the radio unit (100) and further transmit a plurality of signals in response to the connection request.

In an aspect, the radio unit (100) may be implemented in an apparatus (not shown in FIG. 5). In some examples, the apparatus may include but are not limited to repeaters, wireless routers, access points, two-way radios and base stations. As shown in the FIG. 5, the apparatus is shown to be mounted on the base station (506).

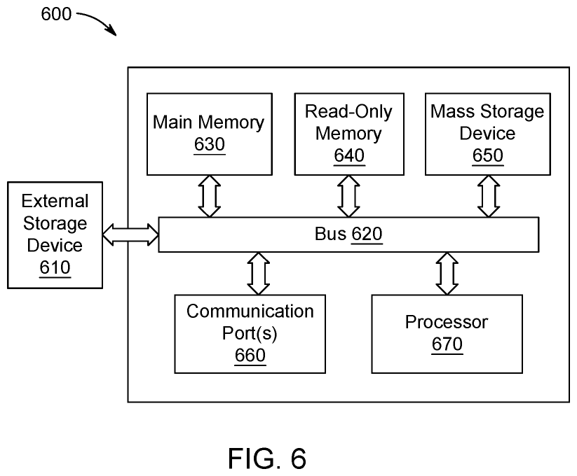

FIG. 6 illustrates an exemplary computer system (600) in which or with which the 4T4R 6G NR low band radio unit may be implemented, in accordance with some embodiments of the present disclosure.

As shown in FIG. 5, the computer system (600) may include an external storage device (610), a bus (620), a main memory (630), a read-only memory (640), a mass storage device (650), communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (660) may be chosen depending on a network, such a Local Area Network (LAN), Wide Area Network (WAN), or any network to which the computer system (600) connects. The main memory (630) may be random access memory (RAM), or any other dynamic storage device commonly known in the art. The read-only memory (640) may be any static storage device(s) including, but not limited to, a Programmable Read Only Memory (PROM) chips for storing static information e.g., start-up or basic input/output system (BIOS) instructions for the processor (670). The mass storage device (650) may be any current or future mass storage solution, which may be used to store information and/or instructions.

The bus (620) communicatively couples the processor (670) with the other memory, storage, and communication blocks. The bus (620) can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (670) to the computer system (600).

Optionally, operator and administrative interfaces, e.g. a display, keyboard, and a cursor control device, may also be coupled to the bus (620) to support direct operator interaction with the computer system (600). Other operator and administrative interfaces may be provided through network connections connected through the communication port(s) (660). In no way should the aforementioned exemplary computer system (600) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides a 4T4R 5G NR low band radio unit comprising lower layer physical (PHY) section, an open radio access network (ORAN) compliant fronthaul on 10G optical interface, a digital front-end support based on commercial grade field programmable gate array (FPGA)/application specific integrated circuit (ASIC), and a plurality of radio frequency (RF) transceiver chains integrated on highly dense four or more layers board.

The present disclosure provides an integrated duplexer filter blind mated with an integrated baseband and transceiver board (IBTB) and an RF front end board (RFEB) resulting in cable less connection.

The present disclosure provides a light weight, compact form factor, and low power consumption radio unit including IP65 ingress protected mechanical housing for proper thermal handling.

The present disclosure provides a radio unit with a frequency division duplexer filter enabling complete isolation between the transmitter and the receiver portions.

The present disclosure provides a multilayer substrate for high power amplifier to accommodate the complex RF and digital signal routing in RFEB.

The present disclosure provides the radio unit with a blind mated and cable less design.

The present disclosure provides the radio unit with a controlled channel gain, thereby reducing the noise figure.

The radio unit of the present disclosure provides increased coverage for indoors and high-rise buildings with enhanced data download rates for outdoor.

The present disclosure provides multiple mounting options for the radio unit enabling deployment flexibility across a wide range of use cases, and therefore, is capable of serving vast customer base with superior connectivity.

We claim:

1. A radio unit (RU) (100) comprising:
an integrated baseband and transceiver board (200) (IBTB (104)) configured to provide an interface (206) for a plurality of radio frequency (RF) transceiver chains (106) based on an integrated circuit, IBTB (104)
an antenna;
a first blindmate;
a second blindmate;
a radio frequency frond end board (RFEB (106)) communicatively coupled to the IBTB (104) comprising the transceiver chains (106) and an observation chain (106), configured to interface (206) the antenna and the IBTB (104); and
a duplexer filter (108) comprising at least one port for transmission chains (106), at least one port for receiver chains (106) and at least one port for the antenna, configured to provide isolation between transmitter chain, and receiver chain and a steeper roll-off outside operating band.

2. The RU claimed as in claim 1, wherein the RFEB (106) comprises a driver (306) amplifier, a digital step attenuator, a power amplifier (PA), and a circulator.

3. The RU claimed as in claim 1, wherein the IBTB (104) comprises a lower layer physical (PHY) component in a network layer, an open radio access network (ORAN) compliant fronthaul on an optical interface (206), and a clock section (204) including a system synchronizer and clock generator module, wherein the system synchronizer and clock generator module is configured to provide precision time protocol (PTP) based clock synchronization on the optical interface(206).

4. The RU claimed as in claim 1, wherein the duplexer filter (108) is an integrated 4×4 high power duplexer (108).

5. The RU claimed as in claim 1, wherein the RFEB (106) is configured to receive a plurality control signals from the IBTB (104) along with a power supply through a connector (110).

6. The RU claimed as in claim 1, wherein the RFEB (106) is connected on the first blind mate with the IBTB (104) and on the second blind mate with the duplexer filter (108).

7. The RU claimed as in claim 1, the RU is configured to increase the system
gain when the system gain decreases beyond a first threshold responsive to temperature, and decrease the system gain when the system gain increases a second threshold responsive to the temperature.

8. The RU claimed as in claim 1, the RU is configured to reduce a system noise figure with digital control.

9. The RU claimed as in claim 1, wherein the IBTB (104) further comprises a digital up converter (DUC), a digital down converter (DDC), a channel frequency response (CFR), a digital pre-distortion (DPD), a digital step attenuator, and a low noise amplifier (LNA).

10. The RU claimed as in claim 1 further comprising a printed circuit board (PCB), the PCB comprises high direct current (DC) power system, plurality of high-speed interfaces running up to 10G, and a high-power RF system into a board including plurality of layers.

11. An apparatus comprising the radio unit (100) as claimed in claim 1.

12. A user equipment (UE) (502) communicatively coupled with a radio unit (100)(RU),
said coupling comprises steps of:
receiving a connection request;
sending an acknowledgment of the connection request to the radio unit(100);
transmitting a plurality of signals in response to the connection request, wherein said radio unit (100) comprising a duplexer filter (108) as claimed in claim 1.
